(19) United States
(12) Patent Application Publication
(10) Pub. No.: US 2008/0005637 A1
(43) Pub. Date: Jan. 3, 2008

(54) METHOD FOR IMPROVING MULTIMEDIA-BROADCASTING QUALITY

(76) Inventors: Kuo-Lung CHANG, Junghe City (TW); Chien-Hsing Wang, Junghe City (TW); Da-Fei Chen, Junghe City (TW); Po-Wen Cheng, Junghe City (TW)

Correspondence Address: SINORICA, LLC, 528 FALLSGROVE DRIVE, ROCKVILLE, MD, 20850, US

(21) Appl. No.: 11/555,733

(22) Filed: Nov. 2, 2006

(30) Foreign Application Priority Data
Jul. 3, 2006 (TW) 095124085

(51) Int. Cl. H04L 1/18; G08C 25/02

(52) U.S. Cl. 714/748

(57) ABSTRACT

A method for improving multimedia-broadcasting quality comprises the steps of: assigning one of receivers as an acknowledger; broadcasting in order the plural information blocks from a sender to the receivers; the acknowledger reporting an acknowledge (ACK) message to the sender at every time that the acknowledger receives one information block; re-broadcasting the information block to the receivers if the sender does not receive the respective ACK message; and repeating broadcasting till all the information blocks are successfully transmitted to the receivers.

### BACKGROUND OF THE INVENTION

(1) Field of the Invention

The invention relates to a method for broadcasting multimedia information, and more particularly to a method for improving multimedia-broadcasting quality.

(2) Description of the Prior Art

Currently, two major wireless communication protocols exist in the networking field; the transmission control protocol (TCP) and the user datagram protocol (UDP). Details in operating the foregoing protocols are described therebelow.

In the TCP, the information packet for communication includes content information and header information. The header information includes an initial address, a destination information, a packet serial number, packet information, a check number and so on. While in using the TCP to transmit the packet, a point-to-point connection between the sender and the receiver shall be established. Also, an information-confirmation process is provided during transmitting the packet so as to tell the real-time transportation state. By providing the real-time transportation state, it can be decided whether or not a “Resend” or an “OK to send the next packet” should be performed.

As mentioned above, using the TCP to transmit information can ensure the transportation quality; especially, the quality in completely and correctly transmitting the information to the receiver. However, clear disadvantages of using the TCP are its low transmission speed, more bandwidth occupation, and the requirement in the exact address of the receiver. In the case that a one-to-multiple information forwarding (i.e. broadcasting) is met, a TCP connection between the sender and each receiver shall be established. Subsequently, the bandwidth occupation in such broadcasting would be proportionally increased, and the broadcast speed would be substantially reduced due to the bandwidth limitation. Therefore, it is obvious that the TCP is suitable to perform neither the real-time multimedia broadcasting nor any information broadcasting.

On the other hand, the UDP is not a connection-direct protocol like the TCP. In a UDP transmission, establishing a connection in between in advance is not necessary. In the UDP transmission, the sender needn't worry about if or not the forwarded information reaches the receiver correctly. The receiver needn't to check if the incoming information is correct or not. Also, a report of a successful receiving from the receiver back to the sender is not required. Thereby, the UDP transmission is faster than the TCP transmission. However, the UDP does not guarantee that the receiver can receive completely the forwarded information.

For a confirmation process is not provided by the UDP communication, the header information of an UDP packet does not include a packet serial number. Therefore, it is not concerned in the UDP whether or not partial information is missed during the transmission. Apparently, the UDP communication is pretty suitable to the information transmission by broadcasting. In particular, most of jobs in forwarding streaming multimedia by a buffering pattern adopt the UDP transmission.

Generally, in the case that some information is missed during a UDP transmission of a multimedia file, the consequence is usually only an image flicker or a discontinue voice, from which the broadcasting quality of the multimedia file is still deemed as an OK. However, as the progress in the zipping technology, the ratio in zipping a multimedia file is also increased. Therefore, it becomes unknown how the missed information may influence the final broadcasting of the multimedia file. Especially, if more than 20% of the information is missed, the transmission of the multimedia file would be definitely unacceptable.

Therefore, the topic how to increase the UDP broadcasting quality becomes one of the crucial issues to the skilled person in the art.

### SUMMARY OF THE INVENTION

Accordingly, it is an object of the present invention to provide a method for improving multimedia-broadcasting quality, in which a dynamic confirmation process is included during the information transmission.

In the present invention, the method for improving multimedia-broadcasting quality comprises the steps of: (a) dividing a multimedia information into a predetermined number (say, N) of information blocks entitled with respective serial numbers, in which each of the information blocks includes at least a packet; (b) assigning one of receivers as an acknowledger; (c) broadcasting an N-th information block from a sender to the receivers; (d) determining if or not the acknowledger receives the N-th information block; (e) the acknowledger reporting an acknowledge (ACK) message to the sender if positive, and repeating step (c) if negative; (f) determining if or not the receivers receive the N-th information block; (g) marking the N-th information as a missed block if negative, and performing step (h) if positive; (h) determining if an accumulated number of the missed blocks at the receivers is larger than a number “i”, or if a counting number of repeating missed blocks is larger than a number “j”; (i) noticing the sender to define the receiver as a far peer if step (h) is positive, and performing step (j) if step (h) is negative; (j) determining if a percentage of a number of the far peers to that of the receivers is larger than M; (k) reassigning another receiver as a new acknowledger if step (j) is positive, and performing step (l) if step (j) is negative; (l) determining if the N-th information block is the last information block of the multimedia information; (m) terminating transmission of the information blocks if step (l) is positive; and (n) using N+1 to replace N and repeating step (c) if step (l) is negative.

In the present invention, the senders utilize the UDP communication protocol to transmit information blocks to the plural receivers, yet the acknowledger as well as the plural receivers utilize the TCP communication protocol to transmit messages back to the sender.

In step (d), in the case that the time for the sender to receive the ACK message from the acknowledger is larger than a predetermined time (for example, 2 Tb), the sender would treat the situation as that the acknowledger and the receivers do not receive the N-th information block; in which the Tb is the time for the receiver process the N-th information block. Under such a situation, the sender will broadcast again the N-th information block to the plural receivers. In the case that the receiver has received the N-th information block, the receiver will discard the resent N-th information block.

In the present invention, the criterion for the sender to assign the acknowledger can be of: (1) assigning the receiver from the plural far peers as the acknowledger by determining which receiver missed most information blocks; (2) assigning the receiver from the plural far peers as the acknowledger by determining which receiver missed least information blocks; or (3) assigning arbitrarily one of the far peers as the acknowledger. Further, every receiver can detect automatically the signal quality of the current WLAN channel, and forward the detected signal quality to the sender. On the other hand, the sender can decide if a switch in the WLAN channel is required according to the detected signal qualities of all the receivers.

All these objects are achieved by the method for improving multimedia-broadcasting quality described below.

### BRIEF DESCRIPTION OF THE DRAWINGS

The present invention will now be specified with reference to its preferred embodiment illustrated in the drawings, in which:

FIG. 1 is a schematic view of a preferred framework of a system that utilizes the method for improving multimedia-broadcasting quality in accordance with the present invention; and

FIG. 2 is a flowchart of the preferred method for improving multimedia-broadcasting quality in accordance with the present invention.

### DESCRIPTION OF THE PREFERRED EMBODIMENT

The invention disclosed herein is directed to a method for improving multimedia-broadcasting quality. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

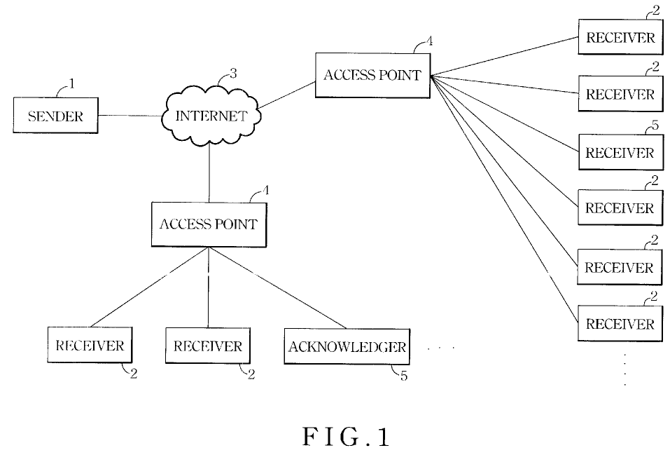

Referring now to FIG. 1, a preferred framework of a system that utilizes the method for improving multimedia-broadcasting quality in accordance with the present invention is shown. The system includes a sender 1 and a plurality of receivers 2. The sender 1 and the receivers 2 are all connected respectively to an internet 3. When information is broadcasted through a wireless network, the receivers 2 in the same area will connect to a common access point (AP) 4 at that area as shown in FIG. 1. In the present invention, at least one of the receivers 2 in the same area will be assigned as the acknowledger 5.

When the sender 1 is to transmit multimedia information to the plural receivers 2 via a UDP communication protocol, the multimedia information needs to be divided into a plurality of information blocks with respective serial numbers. Each of the information blocks is assigned by a receiving time Tb according to its size and the transmission speed. Ideally, the receiver 2 will receive one information block in every Tb time. In the case that the sender 1 haven't received an acknowledge ACK message from the acknowledger within a 2 Tb time, the sender 1 will resend the respective information block.

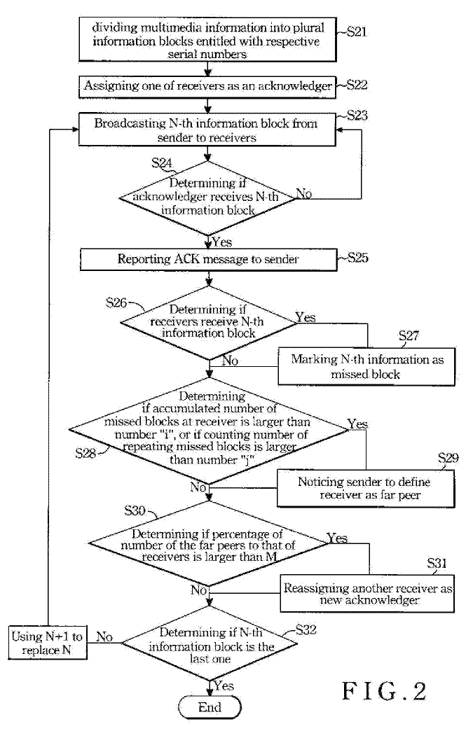

Referring now to FIG. 2, a preferred embodiment of the method for improving multimedia-broadcasting quality in accordance with the present invention is shown. The method includes the steps of: dividing a multimedia information into a predetermined number (say, N) of information blocks entitled with respective serial numbers, in which each of the information blocks includes at least a packet (S21); assigning one of receivers as an acknowledger (S22); broadcasting an N-th information block from a sender to the plural receivers (S23); determining if or not the acknowledger receives the N-th information block (S24); if step S24 is positive, the acknowledger reporting an acknowledge (ACK) message to the sender (S25); if step S24 is negative, the method repeating step S23; determining if or not the receivers receive the N-th information block (S26); if step S26 is negative, the method marking the N-th information as a missed block (S27); if step S26 is positive, performing the following step; determining if an accumulated number of the missed blocks at the receivers is larger than a number “i”, or if a counting number of repeating missed blocks is larger than a number “j” (S28); if step S28 is positive, noticing the sender to define the receiver as a far peer (S29); if step S28 is negative, performing the following step; determining if a percentage of a number of the far peers to that of the receivers is larger than M (S30); if step S30 is positive, reassigning another receiver as a new acknowledger (S31); if step S30 is negative, performing the following step; determining if the N-th information block is the last information block of the multimedia information (S32); if step S32 is positive, terminating transmission of the information blocks (S33); and if step S32 is negative, using N+1 to replace N and repeating step S23 (S34).

In step S25, when the acknowledger receives completely the N-th information block, the ACK message will be reported to the sender via the TCP. At the same time, the sender will confirm if all the receivers at the same area as the acknowledger have received the N-th information block. If the sender hasn't receive the ACK message in a time duration Tb, it is treated as that all the receivers and the acknowledger in the same area have not received the N-th information. Then, step S23 will be repeated. If any receiver has received the N-th information block, the N-th information block will be discarded at this particular receiver.

In the present invention, the sender usually transmits the information blocks in order from the first information block to the last information block. After the N-th information block is successfully transmitted, the next information block will be transmitted by assigning N+1 to be the N (i.e. to draw the next information block into a state ready to be transmitted by the present method). The execution of the present method won't be stopped until the last information block is transmitted. Further, the aforesaid “i” and “j” in step S28 and the “M” in step 30 can be arbitrarily assigned. Basically, the smaller the “i” is, the more reliability is the method. Yet, the transmission speed would be slower.

In the art, information broadcasting through the UDP usually does not include a confirmation function, and thus the UDP data transmission is deemed as a less reliable one. However, in the present invention, though the UDP data transmission is used, yet the introducing of the acknowledger to the receiver area as a typical receiver of that area makes the transmission more reliable. Between the acknowledger and the sender, a TCP connection is established. For the TCP connection won't occupy a larger bandwidth, the transmission quality won't be influenced. Also, for the acknowledger can provide a confirmation function to the transmission of the present method, the reliability of the multimedia broadcasting can be substantially improved.

It is noted that the selection of the acknowledger plays one of major factors to affect the reliability of the method. In particular, if the acknowledger is ill selected, a worse situation that the acknowledger receives the information block but some of the neighboring receivers not may occurs, and thereby the sender will mistreat the situation as a successful transmission. Definitely, the transmission quality and the reliability would be degraded. Contrarily, if most of the neighboring receivers receive the information block but the acknowledger not, the sender will again mistreat that all the receivers in the same area have not received the information block and thus the information block will be resent. Thereby, the internet cost would be raised.

In order to raise the reliability in information transmission and to avoid the cost from repeating transmission, the criterion for the sender to reassign the acknowledger in accordance with the present invention can be as follows.

(a) Assign the receiver from the plural far peers as the acknowledger by determining which receiver missed most information blocks. This type of assigning can ensure the reliability, but may increase the number of repeating transmission.

(b) Assign the receiver from the plural far peers as the acknowledger by determining which receiver missed least information blocks. This type of assigning can't guarantee the reliability, but can reduce the number of repeating transmission.

(c) Assign arbitrarily one of the far peers as the acknowledger. The sender can determine one of the receivers that is most suitable to his/her demands in reliability and the internet cost.

Further, in the present invention, the number of the acknowledgers in the same area is not limited to a single one; i.e. it may be plural. For most of the current wireless communication apparatuses are equipped with an automatic function in detecting the signal quality of the WLAN channels, every receiver of the present invention can also detect automatically the signal quality of the current WLAN channel. Through the TCP connection, every detected signal quality can be forwarded to the sender for deciding if a switch in the WLAN channel is required. Upon such an arrangement, the quality and reliability in wireless multimedia broadcasting can be optimally obtained.

While the present invention has been particularly shown and described with reference to a preferred embodiment, it will be understood by those skilled in the art that various changes in form and detail may be without departing from the spirit and scope of the present invention.

I claim:

1. A method for improving multimedia-broadcasting quality, comprising the steps of:
a. dividing a multimedia information into a predetermined number (say, N) of information blocks;
b. assigning one of plural receivers as an acknowledger;
c. broadcasting an N-th information block from a sender to the plural receivers;
d. determining if or not the acknowledger receives the N-th information block;
e. reporting an acknowledge (ACK) message to the sender if positive, and repeating step (c) if negative;
f. determining if the N-th information block is the last information block of the multimedia information; and
g. terminating transmission of the information blocks if positive, and repeating step (c) after using N+1 to replace the N if negative.

2. The method for improving multimedia-broadcasting quality according to claim 1, wherein said step (e) further includes the steps of:
e1. marking the N-th information as a missed block if any of the receivers does not receive the N-th information block, and performing the following step otherwise;
e2. noticing the sender to define the receiver as a far peer either if an accumulated number of the missed blocks at the receiver is larger than a number “i” or if a counting number of repeating missed blocks is larger than a number “j”, and performing the following step otherwise; and
e3. reassigning another one of the receivers as a new acknowledger if a percentage of a number of the far peers to that of the receivers is larger than M, and performing the following step otherwise.

3. The method for improving multimedia-broadcasting quality according to claim 1, wherein said sender transmits the information block to the receivers via the UDP.

4. The method for improving multimedia-broadcasting quality according to claim 1, wherein said acknowledger transmits the ACK message to the sender via the TCP.

5. The method for improving multimedia-broadcasting quality according to claim 1, wherein a time for the receiver to process the N-th information block in said step (d) is defined as a time duration Tb, and wherein the method deems that all the receivers and the acknowledger have not received the N-th information if the sender hasn't receive the ACK message in a time duration 2 Tb.

6. The method for improving multimedia-broadcasting quality according to claim 1, wherein said receiver discards a repeated N-th information block if the receiver has received the N-th information block.

7. The method for improving multimedia-broadcasting quality according to claim 2, wherein, in said step (e3), said sender selects the receiver from the plural far peers as the acknowledger by determining which receiver missed the most the information blocks.

8. The method for improving multimedia-broadcasting quality according to claim 2, wherein, in said step (e3), said sender selects the receiver from the plural far peers as the acknowledger by determining which receiver missed the least the information blocks.

9. The method for improving multimedia-broadcasting quality according to claim 1, wherein said receiver detects automatically a signal quality of a current WLAN channel, and wherein the signal quality is forwarded to the sender for deciding if a switch in the WLAN channel is required.

10. A method for improving multimedia-broadcasting quality, comprising the steps of:
a. dividing a multimedia information into a predetermined number (say, N) of information blocks;
b. assigning one of plural receivers as an acknowledger;
c. broadcasting an N-th information block from a sender to the plural receivers;
d. determining if or not the acknowledger receives the N-th information block;
e. reporting an acknowledge (ACK) message to the sender if positive, and repeating step (c) if negative;
f. determining if any of the receivers have received the N-th information block;
g. marking the N-th information as a missed block if negative, and performing the following step otherwise;
h. determining either if an accumulated number of the missed blocks at the receiver is larger than a number “i” or if a counting number of repeating missed blocks is larger than a number “j”;
i. noticing the sender to define the receiver as a far peer if positive, and performing the following step otherwise;
j. determining if a percentage of a number of the far peers to that of the receivers is larger than M;
k. reassigning another one of the receivers as a new acknowledger, and performing the following step otherwise;
l. determining if the N-th information block is the last information block of the multimedia information; and
m. terminating transmission of the information blocks if positive, and repeating step (c) after using N+1 to replace the N if negative.

11. The method for improving multimedia-broadcasting quality according to claim 10, wherein said sender transmits the information block to the receivers via the UDP.

12. The method for improving multimedia-broadcasting quality according to claim 10, wherein said acknowledger transmits the ACK message to the sender via the TCP.

13. The method for improving multimedia-broadcasting quality according to claim 10, wherein a time for the receiver to process the N-th information block in said step (d) is defined as a time duration Tb, and wherein the method deems that all the receivers and the acknowledger have not received the N-th information if the sender hasn't receive the ACK message in a time duration 2 Tb.

14. The method for improving multimedia-broadcasting quality according to claim 10, wherein said receiver discards a repeated N-th information block if the receiver has received the N-th information block.

15. The method for improving multimedia-broadcasting quality according to claim 10, wherein, in said step (f), said sender selects the receiver from the plural far peers as the acknowledger by determining which receiver missed the most the information blocks.

16. The method for improving multimedia-broadcasting quality according to claim 10, wherein, in said step (f), said sender selects the receiver from the plural far peers as the acknowledger by determining which receiver missed the least the information blocks.

17. The method for improving multimedia-broadcasting quality according to claim 10, wherein said receiver detects automatically a signal quality of a current WLAN channel, and wherein the signal quality is forwarded to the sender for deciding if a switch in the WLAN channel is required.
